(19) United States
(12) Patent Application Publication
(10) Pub. No.: US 2025/0062399 A1
(43) Pub. Date: Feb. 20, 2025

(54) PROCESS FOR THE PREPARATION OF LITHIUM RARE-EARTH HALIDES

(71) Applicant: SPECIALTY OPERATIONS FRANCE, Lyon (FR)

(72) Inventors: Marc-David Braida, Bry-sur-Marne (FR); Réka Toth, Saint-Genis-Laval (FR)

(73) Assignee: SPECIALTY OPERATIONS FRANCE, Lyon (FR)

(21) Appl. No.: 18/723,813

(22) PCT Filed: Dec. 15, 2022
(86) PCT No.: PCT/EP2022/086174

§ 371 Date: Jun. 24, 2024

(30) Foreign Application Priority Data
Dec. 23, 2021 (EP) 21306918.0

(51) Int. Cl. H01M 10/0562; C01F 17/36

(52) U.S. Cl. CPC H01M 10/0562; C01F 17/36; C01P 2002/50; C01P 2006/40; H01M 2300/008

(57) ABSTRACT

The present invention concerns new lithium rare earth halides that may be used as solid electrolytes or in electrochemical devices. The invention refers to a solution based process for the synthesis of such lithium rare earth halides.

This application claims priority to European patent application No. 21306918.0 filed on Dec. 23, 2021, the whole content of this application being incorporated herein by reference for all purposes.

The present invention concerns lithium rare earth halides that may be used as solid electrolytes or in electrochemical devices. The invention refers to a solution-based process for the synthesis of such lithium rare earth halides.

### PRIOR ART

### Prior Art Documents

### Patent Documents:

Patent Document 1: US 2020/0328453 A1
Patent Document 2: CN 111 785 97 A

### Non Patent Document:

Non patent document 1: Roman Schlemm, Seoseiha Muy, Nils Prinz, Ananya Banik, Yang Shao-Horn, Mirijam Zobel, Wolfgng G. Zeier, Adv. Energy Mater., 2020, 10, 1903719

Lithium batteries are used to power portable electronics and electric vehicles owing to their high energy and power density. Conventional lithium batteries make use of a liquid electrolyte that is composed of a lithium salt dissolved in an organic solvent. The aforementioned system raises security questions as the organic solvents are flammable. Lithium dendrites forming and passing through the liquid electrolyte medium can cause short circuit and produce heat, which result in accident that leads to serious injuries. Since the electrolyte solution is a flammable liquid, there is a concern of occurrence of leakage, ignition or the like when used in a battery. Taking such concern into consideration, development of a solid electrolyte having a higher degree of safety is expected as an electrolyte for a next-generation lithium battery.

Non-flammable inorganic solid electrolytes offer a solution to the security problem. Furthermore, their mechanic stability helps suppressing lithium dendrite formation, preventing self-discharge and heating problems, and prolonging the life-time of a battery.

Glass and glass ceramic electrolytes are advantageous for lithium battery applications due to their high ionic conductivities and mechanical properties. These electrolytes can be pelletized and attached to electrode materials by cold pressing, which eliminates the necessity of a high temperature assembly step. Elimination of the high temperature sintering step removes one of the challenges against using lithium metal anodes in lithium batteries. Due to the wide-spread use of all solid state lithium batteries, there is an increasing demand for solid state electrolytes having a high conductivity for lithium ions.

Several processes exist for the preparation of lithium rare-earth halides comprising the reaction of anhydrous rare-earth metal halides and lithium halide. For instance, lithium rare-earth halides were synthesized by mechanochemical milling or solid-state synthesis. Patent document 1 discloses the reaction of anhydrous rare-earth metals with lithium halides by grounding, mixing and subsequent milling. Non patent document 1 discloses synthesis methods of mechanochemical milling, subsequent crystallization routes and classical solid-state synthesis of lithium rare-earth halides starting from anhydrous rare-earth metal halides and lithium halides. Patent document 2 discloses the synthesis of Li₃ YCl₆ via a full solution route. Thereby, dry (i.e. anhydrous) YCl₃ is dissolved in ethanol with lithium chloride to prepare a Li₃YCl₆ coating on active materials after a sintering step between 200° C. and 400° C.

However, anhydrous rare-earth metal halides as starting materials are costly to produce.

There is hence a need for a process of preparing lithium rare-earth halides not exhibiting the above-mentioned disadvantage. In particular, there is a need for of preparing lithium rare-earth halides using cheap precursors.

### INVENTION

It is a problem of the invention to provide a process for synthesizing alkaline rare-earth halide compounds using cheap hydrated rare-earth halide precursors which exhibit similar performances as alkaline rare-earth halides that has been synthesized starting from anhydrous rare-earth halide precursors.

It has now been found that the above-mentioned problems can be solved by the process according to the present invention.
[Item 1] The present invention relates to a process for the preparation of a solid material according to general formula (I) as follows:

Li_{6-3x-my}REₓT_{y}X₆ (I)
wherein:
X is a halogen;
m is the valence of the element T;
0<x+(m/3)y<2; preferably 0.8≤x+(m/3)y≤1.5; more preferably 0.95≤x+(m/3)y≤1.25;
0≤y≤0.8; preferably 0.1≤y≤0.7; more preferably 0.2≤y≤0.6;
RE denotes one or more rare earth metals; the rare earth metals are different from each other; and
T is selected from the group consisting of Zr, Hf, Al, Zn, Mg, Ca, Sr, Bi, Nb, Fe and Ta;
said process comprising the step of:
a) dissolving lithium halide, at least one hydrated rare-earth metal halide and optionally T halide in a solvent to obtain a solution.
[Item 2] Process according to item 1 wherein the solid material is any one of the compounds of formulas (II) to (V) as follows:

Li_{6-3x-my}RE1ₐRE2_{b}T_{y}X₆ (II)
wherein a+b=x, with 0.05≤a≤0.95 and 0.0<b≤0.95; preferably 0.5≤a≤0.9 and 0.05<b≤0.5;

Li_{6-3x-my}RE1ₐRE2_{b}RE3_{c}T_{y}X₆ (III)
wherein a+b+c=x, with 0.05≤a≤0.95, 0.0<b≤0.95 and 0.0<c≤0.95 with 0.05<b+c;

Li_{6-3x-my}RE1ₐRE2_{b}RE3_{c}RE4_{d}T_{y}X₆ (IV)
wherein a+b+c+d=x, with 0.05≤a≤0.95, 0.0<b≤0.95, 0.0<c≤0.95 and 0.0<d≤0.95 with 0.05<b+c+d;

Li_{6-3x-my}RE1ₐRE2_{b}RE3_{c}RE4_{d}RE5ₑT_{y}X₆ (V)
wherein a+b+c+d+e=x, with 0.05≤a≤0.95, 0.0<b≤0.95, 0.0<c≤0.95, 0.0<d≤0.95 and 0.0<e≤0.95, with 0.05≤b+c+d+e; and
wherein
X is a halogen,
0<x+(m/3)y<2; preferably 0.8≤x+(m/3)y≤1.5; more preferably 0.95≤x+(m/3)y≤1.25;
0≤y≤0.8; preferably 0.1≤y≤0.7; more preferably 0.2≤y≤0.6;
RE1 is selected from the group consisting of Y, Yb, Ho and Er;
RE2 is selected from the group consisting of Yb, Ho, Gd, Er, Sm, Dy, La, Nd, Ce and Tb;
RE3 is selected from the group consisting of Ho, Gd, Er, Sm, Dy La, Nd, Ce and Tb;
RE4 is selected from the group consisting of Er, Gd Sm, Dy La, Nd, Ce and Tb; and
RE5 is selected from the group consisting of Gd Sm, Dy La, Nd, Ce and Tb; where RE1, RE2, RE3, RE4 and RE5 are different; and
T is selected from the group consisting of Zr, Hf, Al, Zn, Mg, Ca, Sr, Bi, Nb, Fe and Ta.
[Item 3] Process according to item 1 or 2 wherein the lithium halides are selected from the group consisting of LiCl, LiBr, LiF, and LiI.
[Item 4] Process according to any one of items 1 to 3 wherein hydrated rare-earth metal halides are selected from the group consisting of YCl₃·6H₂O, ErCl₃·6H₂O, YbCl₃·6H₂O, GdCl₃·6H₂O, LaCl₃·6H₂O, YBr₃·6H₂O, ErBr₃·6H₂O, YbBr₃·6H₂O, GdBr₃·6H₂O, LaBr₃·6H₂O, (Y, Yb, Er)Cl₃·6H₂O and (La, Y)Cl₃·6H₂O.
[Item 5]. Process according to any one of items 1 to 4 wherein the T halide is ZrCl₄.
[Item 6]. Process according to any one of items 1 to 5 wherein the solvent is selected from the group consisting of alcohols, nitriles and ethers.
[Item 7]. Process according to item 6 wherein the alcohol is selected from the group consisting of methanol, ethanol, n-propanol, iso-propanol and butanol, preferably ethanol.
[Item 8] Process according to item 6 wherein the ether is tetrahydrofuran.
[Item 9] Process according to item 6 wherein the nitrile is acetonitrile.
[Item 10] Process according to any one of items 1 to 9 wherein the solvent is a dry solvent.
[Item 11] Process according to any one of items 1 to 10 wherein step a) is carried out with stoichiometric amounts of a lithium halide and at least one hydrated rare-earth metal halide.
[Item 12] Process according to any one of items 1 to 11 wherein the process further comprises the step of:
b) removing at least a part of the solvent from the solution obtained in step a) in order to obtain the solid material.
[Item 13] Process according to item 12 wherein the process further comprises the step of:
c) calcinating the solid material obtained in step b).
[Item 14] Process according to claim 13 wherein the calcinating is carried from about 100° C. to about 500° C. from about 30 minutes to about 4 hours.
[Item 15] Process according to any one of items 1 to 14 wherein at least one of steps a) to c) is carried out under inert atmosphere.

### DEFINITIONS

Throughout this specification, unless the context requires otherwise, the word “comprise” or “include”, or variations such as “comprises”, “comprising”, “includes”, including” will be understood to imply the inclusion of a stated element or method step or group of elements or method steps, but not the exclusion of any other element or method step or group of elements or method steps. According to preferred embodiments, the word “comprise” and “include”, and their variations mean “consist exclusively of”.

As used in this specification, the singular forms “a”, “an” and “the” include plural aspects unless the context clearly dictates otherwise. The term “and/or” includes the meanings “and”, “or” and also all the other possible combinations of the elements connected to this term.

The term “between” should be understood as being inclusive of the limits. Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 120° C. to about 150° C. should be interpreted to include not only the explicitly recited limits of about 120° C. to about 150° C., but also to include sub-ranges, such as 125° C. to 145° C., 130° C. to 150° C., and so forth, as well as individual amounts, including fractional amounts, within the specified ranges, such as 122.2° C., 140.6° C., and 141.3° C., for example. In particular, the term “about” means ±10% of the specified numeric value, preferably ±5% and most preferably ±2%.

As used herein, the term “crystalline phase” refers to a material or a fraction of a material that exhibits a crystalline property, for example, well-defined x-ray diffraction peaks as measured by X-Ray Diffraction (XRD).

As used herein, the term “peaks” refers to (2Θ) positions on the x-axis of an XRD powder pattern of intensity v. degrees (2Θ) which have a peak intensity substantially greater than the background. In a series of XRD powder pattern peaks, the primary peak is the peak of highest intensity which is associated with the compound, or phase, being analyzed. The second primary peak is the peak of second highest intensity. The third primary peak is the peak of third highest intensity.

As used herein, the term “hydrated rare-earth halides” refers to REX·6H₂O, where RE denotes at least a rare-earth metal and X denotes a halogen.

### DETAILED INVENTION

The invention relates to a process for the preparation of a solid material of formula (I):

Li_{6-3x-my}REₓT_{y}X₆ (I)
wherein:
X is a halogen;
m is the valence of the element T;
0<x+(m/3)y<2; preferably 0.8≤x+(m/3)y≤1.5; more preferably 0.95≤x+(m/3)y≤1.25;
0≤y≤0.8; preferably 0.1≤y≤0.7; more preferably 0.2≤y≤0.6;
RE denotes one or more rare earth metals; the rare earth metals are different from each other; and
T is selected from the group consisting of Zr, Hf, Al, Zn, Mg, Ca, Sr, Bi, Nb, Fe and Ta;
with the proviso that when y=0 and RE denotes two rare earth metals, then when one is Y, the other one is selected from the group consisting of Gd, Yb, Ho, Er, Dy, Ce, Tb and Nd.

In a first embodiment of the invention, y=0 and the solid material is of formula (Ia)

Li₆₋₃ₓREₓX₆ (Ia)
wherein:
X is a halogen;
0<x<2; preferably 0.8≤x≤1.5; more preferably 0.95≤x≤1.25; and
RE denotes one or more rare earth metals; the rare earth metals are different from each other; with the proviso that when RE denotes two rare earth metals, when one is Y, the other one is selected from the group consisting of Gd, Yb, Ho, Er, Dy, Ce, Tb and Nd.

The solid material obtained by the invention is neutrally charged. It is understood that formula (I)/(Ia) is an empirical formula (gross formula) determined by means of elemental analysis. Accordingly, formula (I) defines a composition which is averaged over all phases present in the solid material.

The 17 rare-earth elements are cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y).

X is a halogen selected from the group consisting of F, CI, I and Br, X is preferably Cl or Br.

In Formula (Ia): 0<x<2; preferably 0.8≤x≤1.5; more preferably 0.95≤x≤1.25. Particularly x is 0.1, 0.2, 0.3, 0.4, 0.5, 0.6, 0.7, 0.8, 0.9, 1, 1.1, 1.1, 1.3, 1.4 and 1.5 or any range made from these values.

The solid material obtained by the invention may be amorphous (glass) and/or crystallized (glass ceramics). Only part of the solid material may be crystallized. The crystallized part of the solid material may comprise only one crystal structure or may comprise a plurality of crystal structures. The content of amorphous and crystalline constituents in the solid material could be evaluated using a whole powder pattern fitting (WPPF) technique with an Al₂O₃ crystal, which is a typical reference material, as described in “RSC Adv., 2019, 9, 14465”. Solid material obtained by the invention preferably comprises a fraction consisting of glass phases.

The composition of the compound of formula (I)/(Ia) may notably be determined by chemical analysis using techniques well known to the skilled person, such as for instance a X-Ray Diffraction (XRD) and an Inductively Coupled Plasma-Mass Spectrometry (ICP-MS).

Preferably the mean ionic radius of RE, i.e. the average ionic radius values of the rare earth metals, exhibits an ionic radius value (in Å) lower than 0.938 Å. Each of the rare earth metal composing RE (for instance REI and RE2) does not have to fulfill this condition. Mean radius can be define as the arithmetical mean of the radii of the rare-earth (RE³⁺ in 6-fold coordination number) in the compound. For instance, according to the invention mean radius may be equal to:
0.904 Å wherein REI is Y (90% mol) and RE2 is Gd (10% mol);
0.895 Å wherein REI is Y (50% mol) and RE2 is Er (50% mol);

The solid material obtained by the invention may have formula (II) as follows:

Li_{6-3x-my}RE1ₐRE2_{b}T_{y}x₆ (II)
wherein:
X is a halogen;
m is the valence of the element T;
0<x+(m/3)y<2; preferably 0.8≤x+(m/3)y≤1.5; more preferably 0.95≤x+(m/3)y≤1.25;
0≤y≤0.8; preferably 0.1≤y≤0.7; more preferably 0.2≤y≤0.6;
a+b=x, with 0.05≤a≤0.95 and 0.0<b≤0.95; preferably 0.5≤a≤0.9 and 0.05<b≤0.5;
RE1 is selected from the group consisting of Y, Yb, Ho and Er;
RE2 is selected from the group consisting of Yb, Ho, Gd, Er, Sm, Dy, La, Nd, Ce and Tb; where REI and RE2 are different; and
T is selected from the group consisting of Zr, Hf Al, Zn, Mg, Ca, Sr, Bi, Nb, Fe and Ta,
with the proviso that when y=0 and RE1 is Y, RE2 is selected from the group consisting of Gd, Yb, Ho, Er, Dy, Ce, Tb and Nd.

When y-0, the solid material has formula (IIa) as follows:

Li₆₋₃ₓRE1ₐRE2_{b}X₆ (IIa)
wherein:
X is a halogen;
0<x<2; preferably 0.8≤x≤1.5; more preferably 0.95≤x≤1.25;
a+b=x, with 0.05≤a≤0.95 and 0.0<b≤0.95; preferably 0.5≤a≤0.9 and 0.05<b≤0.5;
RE1 is selected from the group consisting of Y, Yb, Ho and Er; and
RE2 is selected from the group consisting of Gd, Y, Yb, Ho, Er, Sm, Dy, Ce, Tb, La and Nd; with RE1 different from RE2;
with the proviso that when RE1 is Y, RE2 is selected from the group consisting of Gd, Yb, Ho, Er, Dy, Ce, Tb and Nd.

Preferably the mean ionic radius of RE, ie. the average ionic radius values of the rare earth metals RE1 and RE2, exhibits an ionic radius value (in Å) lower than 0.938 Å.

Preferably solid materials of formula (II)/(IIa) obtained by the present invention may be as follows:

| | | | | | | Mean |
|---|---|---|---|---|---|---|
| | | | | | | Rare-earth |
| | | | | | | Ionic Radius |
| x | X | RE1 | a | RE2 | b | (Å) |
| 1 | Cl | Y | 0.9 | Gd | 0.1 | 0.904 |
| 1.1 | Cl | Y | 1 | Gd | 0.1 | 0.903 |
| 1 | Cl | Y | 0.5 | Er | 0.5 | 0.895 |

Solid material may also be a compound of formula (III) as follows:

Li_{6-3x-my}RE1ₐRE2_{b}RE3_{c}T_{y}X₆ (III)
wherein:
X is a halogen;
m is the valence of the element T;
0<x+(m/3)y<2; preferably 0.8≤x+(m/3)y≤1.5; more preferably 0.95≤x+(m/3)y≤1.25;
0≤y≤0.8; preferably 0.1≤y≤0.7; more preferably 0.2≤y≤0.6;
a+b+c=x, with 0.05≤a≤0.95, 0.0<b≤0.95 and 0.0<c≤0.95 with 0.05sb+c;
RE1 is selected from the group consisting of Y, Yb, Ho and Er;
RE2 is selected from the group consisting of Yb, Ho, Gd, Er, Sm, Dy, La, Nd, Ce and Tb;
RE3 is selected from the group consisting of: Ho, Gd, Er, Sm, Dy La, Nd, Ce and Tb;
where RE1, RE2 and RE3 are different; and
T is selected from the group consisting of Zr, Hf, Al, Zn, Mg, Ca, Sr, Bi, Nb, Fe and Ta.

When y=0, the solid material is a compound of formula (IIIa) as follows:

Li₆₋₃ₓRE₁ₐRE_{2b}RE_{3c}X₆ (IIIa)
wherein:
X is a halogen;
0<x<2; preferably 0.8≤x≤1.5; more preferably 0.95≤x≤1.25;
a+b+c=x, with 0.05≤a≤0.95, 0.0<b≤0.95 and 0.0<c≤0.95 with 0.05 sb+c;
RE1 is selected from the group consisting of Y, Yb, Ho and Er;
RE2 is selected from the group consisting of Yb, Ho, Gd, Er, Sm, Dy, La, Nd, Ce and Tb; and
RE3 is selected from the group consisting of: Ho, Gd, Er, Sm, Dy, La, Nd Ce and Tb; where RE1, RE2 and RE3 are different.

Preferably the mean ionic radius of RE, ie. the average ionic radius values of the rare earth metals RE1, RE2 and RE3, exhibits an ionic radius value (in Å) lower than 0.938 Å.

Preferably solid materials of formula (III)/(IIIa) obtained by the present invention may be as follows:

| | | | | | | | | Mean |
|---|---|---|---|---|---|---|---|---|
| | | | | | | | | Rare-earth |
| | | | | | | | | Ionic Radius |
| x | X | RE1 | a | RE2 | b | RE3 | c | (Å) |
| 1 | Cl | Y | 0.45 | Er | 0.45 | Gd | 0.1 | 0.899 |
| 1 | Cl | Y | 0.45 | Er | 0.45 | La | 0.1 | 0.909 |

Solid material obtained by the invention may also be a compound of formula (IV) as follows:

Li_{6-3x-my}RE1ₐRE2_{b}RE3_{c}RE4_{d}T_{y}X₆ (IV)
wherein:
X is a halogen;
m is the valence of the element T;
0<x+(m/3)y<2; preferably 0.8≤x+(m/3)y≤1.5; more preferably 0.95≤x+(m/3)y≤1.25;
0≤y≤0.8; preferably 0.1≤y≤0.7; more preferably 0.2≤y≤0.6;
a+b+c+d=x, with 0.05≤a≤0.95, 0.0<b≤0.95, 0.0<c≤0.95 and 0.0<d≤0.95 with 0.05≤b+c+d;
RE1 is selected from the group consisting of Y, Yb, Ho and Er;
RE2 is selected from the group consisting of Yb, Ho, Gd, Er, Sm, Dy, La, Nd, Ce and Tb;
RE3 is selected from the group consisting of Ho, Gd, Er, Sm, Dy La, Nd, Ce and Tb;
RE4 is selected from the group consisting of Er, Gd Sm, Dy La, Nd, Ce and Tb; where RE1, RE2, RE3 and RE4 are different; and
T is selected from the group consisting of Zr, Hf, Al, Zn, Mg, Ca, Sr, Bi, Nb, Fe or Ta.

When y=0, the solid material is a compound of formula (IVa) as follows:

Li₆₋₃ₓRE1ₐRE2_{b}RE3_{c}RE4_{d}X₆ (IVa)
wherein
X is a halogen;
0<x<2; preferably 0.8≤x≤1.5; more preferably 0.95≤x≤1.25;
a+b+c+d=x, with 0.05≤a≤0.95, 0.0<b≤0.95, 0.0<c≤0.95 and 0.0<d≤0.95 with 0.05<b+c+d;
RE1 is selected from the group consisting of Y, Yb, Ho and Er;
RE2 is selected from the group consisting of Yb, Ho, Gd, Er, Sm, Dy, La, Nd, Ce and Tb;
RE3 is selected from the group consisting of Ho, Gd, Er, Sm, Dy, La, Nd, Ce and Tb; and
RE4 is selected from the group consisting of Gd, Er, Sm, Dy La, Nd, Ce and Tb; where RE1, RE2, RE3 and RE4 are different.

Preferably the mean ionic radius of RE, ie. the average ionic radius values of the rare earth metals RE1, RE2, RE3 and RE4, exhibits an ionic radius value (in Å) lower than 0.938 Å.

Preferably solid materials of formula (IV)/(IVa) obtained by the present invention may be as follows:

| | | | | | | | | | | Mean |
|---|---|---|---|---|---|---|---|---|---|---|
| | | | | | | | | | | Rare-earth |
| | | | | | | | | | | Ionic Radius |
| x | X | RE1 | a | RE2 | b | RE3 | c | RE4 | d | (Å) |
| 1 | Cl | Y | 0.3 | Yb | 0.3 | Er | 0.3 | Gd | 0.1 | 0.891 |
| 1.1 | Cl | Y | 0.3 | Yb | 0.3 | Er | 0.3 | La | 0.2 | 0.912 |
| 1 | Cl | Y | 0.25 | Yb | 0.25 | Ho | 0.25 | Er | 0.25 | 0.889 |

Solid material obtained by the invention may also be a compound of formula (V) as follows:

Li_{6-3x-my}RE1ₐRE2_{b}RE3_{c}RE4_{d}RE5ₑT_{y}X₆ (V)
wherein:
X is a halogen,
m is the valence of the element T,
0<x+(m/3)y<2; preferably 0.8≤x+(m/3)y≤1.5; more preferably 0.95≤x+(m/3)y≤1.25;
0≤y≤0.8; preferably 0.1≤y≤0.7; more preferably 0.2≤y≤0.6;
a+b+c+d+e=x, with 0.05≤a≤0.95, 0.0<b≤0.95, 0.0<c≤0.95, 0.0<d≤0.95 and 0.0<e≤0.95, with 0.05≤b+c+d+e;
RE1 is selected from the group consisting of Y, Yb, Ho and Er;
RE2 is selected from the group consisting of Yb, Ho, Gd, Er, Sm, Dy, La, Nd, Ce and Tb;
RE3 is selected from the group consisting of Ho, Gd, Er, Sm, Dy La, Nd, Ce and Tb;
RE4 is selected from the group consisting of Er, Gd Sm, Dy La, Nd, Ce and Tb; and
RE5 is selected from the group consisting of Gd Sm, Dy La, Nd, Ce and Tb; where RE1, RE2, RE3, RE4 and RE5 are different; and
T is selected from the group consisting of Zr, Hf, Al, Zn, Mg, Ca, Sr, Bi, Nb, Fe and Ta.

When y=0, the solid material is a compound of formula (Va) as follows:

Li₆₋₃ₓRE1ₐRE2_{b}RE3_{c}RE4_{d}RE5ₑX₆ (Va)
wherein
X is a halogen;
0<x<2; preferably 0.8≤x≤1.5; more preferably 0.95≤x≤1.25;
a+b+c+d+e=x, with 0.05≤a≤0.95, 0.0<b≤0.95, 0.0<c≤0.95, 0.0<d≤0.95 and 0.0<e≤0.95, with 0.05≤b+c+d+e;
RE1 is selected from the group consisting of Y, Yb, Ho and Er;
RE2 is selected from the group consisting of Yb, Ho, Gd, Er, Sm, Dy, La, Nd, Ce and Tb;
RE3 is selected from the group consisting of Ho, Gd, Er, Sm, Dy La, Nd, Ce and Tb;
RE4 is selected from the group consisting of Er, Gd Sm, Dy La, Nd, Ce and Tb; and
RE5 is selected from the group consisting of Gd Sm, Dy La, Nd, Ce and Tb; where RE1, RE2, R3, R4 and RE5 are different.

Preferably the mean ionic radius of RE, ie. the average ionic radius values of the rare earth metals RE1, RE2, RE3, RE4 and RE5, exhibits an ionic radius value (in Å) lower than 0.938 Å.

Preferably solid materials of formula (V)/(Va) obtained by the present invention may be as follows:

| | | | | | | | | | | | | Mean |
|---|---|---|---|---|---|---|---|---|---|---|---|---|
| | | | | | | | | | | | | Rare-earth |
| | | | | | | | | | | | | Ionic Radius |
| x | X | RE1 | a | RE2 | b | RE3 | c | RE4 | d | RE5 | e | (Å) |
| 1 | Cl | Y | 0.2 | Yb | 0.2 | Ho | 0.2 | Er | 0.2 | Gd | 0.2 | 0.899 |
| 1 | Cl | Y | 0.8 | Yb | 0.05 | Ho | 0.05 | Er | 0.05 | Gd | 0.05 | 0.900 |
| 1.1 | Cl | Y | 0.9 | Yb | 0.05 | Ho | 0.05 | Er | 0.05 | Gd | 0.05 | 0.900 |

Preferably the solid materials obtained by the invention are selected from the group consisting of: Li₃YCl₆, Li₃Y_{0.9}Gd_{0.1}Cl₆; Li₃Y_{0.3}Er_{0.3}Yb_{0.3}Gd_{0.1}Cl₆, Li_{2.7}Y₁Gd_{0.1}Cl₆; Yi₃Y_{0.5}Er_{0.5}Cl₆; Li₃Y_{0.45}Er_{0.45}Gd_{0.1}Cl₆; and Li₃Y_{0.45}Er_{0.45}La_{0.1}Cl₆.

Solid materials obtained by the invention may be in powder form with a distribution of particle diameters having a D50 preferably comprised between 0.05 μm and 10 μm. The particle size can be evaluated with SEM image analysis or laser diffraction analysis.

D50 has the usual meaning used in the field of particle size distributions. Dn corresponds to the diameter of the particles for which n % of the particles have a diameter which is less than Dn. D50 (median) is defined as the size value corresponding to the cumulative distribution at 50%. These parameters are usually determined from a distribution in volume of the diameters of a dispersion of the particles of the solid material in a solution, obtained with a laser diffractometer, using the standard procedure predetermined by the instrument software. The laser diffractometer uses the technique of laser diffraction to measure the size of the particles by measuring the intensity of light diffracted as a laser beam passes through a dispersed particulate sample. The laser diffractometer may be the Mastersizer 3000 manufactured by Malvern for instance.

D50 may be notably measured after treatment under ultrasound. The treatment under ultrasound may consist in inserting an ultrasonic probe into a dispersion of the solid material in a solution, and in submitting the dispersion to sonication.

The invention also refers to a method for producing solid materials, notably solid materials of formulas (I), (Ia), (II), (IIa), (III), (IIIa), (IV), (IVa), (V) and (Va) as previously expressed, comprising dissolving at least a lithium halide, at least a hydrated rare-earth metal halide, in such halides the rare-earth metal are different from each other and optionally zirconium, hafnium, aluminum, zinc, magnesium, calcium, strontium, bismuth, niobium, iron or tantalum halide in a solvent to obtain a solution.

One or more lithium halides may notably be used.

Solid materials, notably according to formulas (I), (Ia), (II), (IIa), (III), (IIIa), (IV), (IVa), (V) and (Va) as previously expressed are produced by a solution-based process.

The invention refers to a process for the preparation of solid materials as previously expressed, notably according to general formulas (I), (Ia), (II), (IIa), (III), (IIIa), (IV), (IVa), (V) and (Va), said process comprising the step of:
a) dissolving lithium halide, at least a hydrated rare-earth metal halide and optionally zirconium, hafnium, aluminum, zinc, magnesium, calcium, strontium, bismuth, niobium, iron or tantalum halide in a solvent to obtain a solution.

In step (a) the composition ratio of each element can be controlled by adjusting the amount of the raw material compound when the solid material is produced. The precursors and their molar ratio are preferably selected according to the target stoichiometry. The target stoichiometry defines the ratio between the elements Li, RE, T and X, which is obtainable from the applied amounts of the precursors under the condition of complete conversion without side reactions and other losses. Lithium halide refers to a compound including one or more of sulfur atoms and one or more of halogen atoms, or alternatively, one or more of halogen containing ionic groups and one or more of lithium containing ionic groups. In certain preferred aspects, lithium halide may consist of halogen atoms and lithium atoms. Preferably, lithium halide is LiCl, LiBr, LiF, and LiI.

Hydrated rare-earth metal halide compounds refer to a compound including one or more of halogen atoms such as F, Cl, Br, or I via chemical bond (e.g., ionic bond or covalent bond) to the other atoms constituting the compound. In certain preferred aspect, the halogen compound may include one or more of F, Cl, Br, I, or combinations thereof and one or more rare-earth metal atoms. Non-limiting examples may suitably include YCl₃·6H₂O, ErCl₃·6H₂O, YbCl₃·6H₂O, GdCl₃·6H₂), LaCl₃·6H₂, YBr₃19 6H₂O, ErBr₃1·6H₂O, YbBr₃·6H₂O, GbBr₃·6H₂O, and LaBr₃·6H₂O. Mixed hydrated rare-earth halides REX3 can also be used as precursors, non limiting examples are (Y, Yb, Er)Cl₃·6H₂O and (La, Y)Cl₃·6H₂O. Hydrated rare-earth metal halide compounds are preferably selected from the group consisting of YCl₃·6H₂O, ErCl₃·6H₂O, YbCl₃·6H₂O, GdCl₃·6H₂O, LaCl₃·6H₂O, YBr₃·6H₂O, ErBr₃·6H₂O, YbBr₃19 6H₂O, GdBr₃·6H₂O, LaBr₃19 6H₂O, (Y, Yb, Er)Cl₃·6H₂O and (La, Y)Cl₃·6H₂O.

It is perfectly possible to use one or several hydrated rare-earth metal halides, notably in which the rare-earth metals are different from each other.

Preferably, lithium halides and hydrated rare-earth halides have an average particle diameter comprised between 0.5 μm and 400 μm. The particle size can be evaluated with SEM image analysis or laser diffraction analysis.

It is also possible to add to the solution of step a) a dopant, preferably an aliovalent dopant to create lithium vacancies, such as zirconium, hafnium aluminum, zinc, magnesium, calcium, strontium, bismuth, niobium, iron or tantalum for instance. Any zirconium, hafnium, aluminum, zinc, magnesium, calcium, strontium, bismuth, niobium, iron or tantalum halide including one or more of halogen atoms such as F, Cl, Br, or I added to the solution of step a) are suitable for this purpose. Preferably ZrCl₄ is added to the solution of step a).

The solution in step a) comprises one or more solvents. The solvent may suitably be selected from protic or aprotic solvents that are dissolving lithium halides and hydrated rare-earth metal halides.

Preferably, the solvent is selected from alcohols, ethers or nitriles.

Preferred alcohols are methanol, ethanol, n-propanol, iso-propanol and butanol. More preferably, the solvent is ethanol.

Preferred ethers are tetrahydrofuran, dioxane and methyl tert-butyl ether, more preferably, the ether is tetrahydrofuran.

Preferred nitriles are acetonitrile and benzonitrile, more preferably, the nitrile is acetonitrile.

Preferably the solvent is a dry solvent. The solvent can be dried by any method known in the art such as drying agents or distillation methods. Preferably, the solvent is dried via molecular beads. The solvent can be dried in advance or the solvent can be dried after dissolving the precursors. Preferably, the solvent is dried after dissolving the precursors.

In step a), there are no particular limitations on the dissolving of the at least one hydrated rare earth metal halide in a solvent. Preferably, the dissolving is carried out via shacking the mixture for several minutes.

In step a), there are no particular limitations on the temperature, but preferably in step a), the temperature is from about 0° C. to 60° C., more preferably from about 5° C. to 50° C., even more preferably of from 15° C. to 30° C., and most preferably about room temperature.

Step (a) is preferable carried out under inert atmosphere. Inert atmosphere refers to the use of an inert gas; i.e. a gas that does not undergo detrimental chemical reactions under conditions of the reaction. Inert gases are used generally to avoid unwanted chemical reactions from taking place, such as oxidation and hydrolysis reactions with the oxygen and moisture in air. Hence inert gas means gas that does not chemically react with the other reagents present in a particular chemical reaction. Within the context of this disclosure the term “inert gas” means a gas that does not react with the solid material precursors. Examples of an “inert gas” include, but are not limited to, nitrogen, helium, argon, carbon dioxide, neon, xenon, O₂ with less than 1000 ppm of liquid and airborne forms of water, including condensation. The gas can also be pressurized. inert atmosphere comprises an inert gas such as dry N₂, dry Argon or dry air (dry may refer to a gas with less than 800 ppm of liquid and airborne forms of water, including condensation).

In such a condition, lithium halides and hydrated rare-earth halides are allowed to react for a predetermined period of time.

Preferably the process for production of a solid material according to general formulas (I), (Ia), (II), (IIa), (III), (IIIa), (IV), (IVa), (V) and (Va) further comprises a step (b) of removing at least a part of the solvent from the solution obtained in step (a) in order to obtain the solid material.

It's perfectly possible to remove at least a part of the solvent, for instance in order to remove at least 90%, 91%, 92%, 93%, 94%, 95%, 96%, 97%, 98%, 99% or 100%, of the total weight of a solvent used, or any ranges comprised between these values, such as from 90% to 95 or 96% to 99%. Solvent removal may be carried out by known methods used in the art, such as decantation, filtration, centrifugation, drying or a combination thereof.

Preferably when drying is selected as method for solvent removal, temperature is selected below ebullition temperature and as a function of vapor partial pressure of the selected solvent.

Duration is between 1 second and 100 hours, preferably between 1 hour and 20 hours. Such a low duration may be obtained for instance by using a flash evaporation, such as by spray drying.

Removal of the solvent may be conducted under an atmosphere of an inert gas such as nitrogen or argon. The dew point of an inert gas is preferably −20° C. or less, particularly preferably −40° C. or less. The pressure may be from 0.0001 Pa to 100 MPa, preferably from 0.001 Pa to 20 MPa, preferably from 0.01 Pa to 20 MPa. Notably the pressure may range from 0.0001 Pa to 0.001 Pa, notably by using ultravacuum techniques. Notably the pressure may range from 0.01 Pa to 0.1 MPa by using primary vacuum techniques.

It's also perfectly possible to heat the solid material after step a) and b). The heating, or thermal treatment, may notably allow converting the amorphized powder mixture (glass) obtained above into a solid material crystalline or mixture of glass and crystalline (glass ceramics).

Heat treatment is carried out at a temperature in the range of from 50° C. to 700° C., notably for a duration of 1 minute to 100 hours, preferably from 30 minutes to 20 hours, more preferably in the range of 1.5 to 2.5 hours and most preferably for 2 hours. Preferably, the heat treatment is carried out at a temperature in the range of from 100° C. to 400° C., preferably in the range of from 150° C. to 350° C., and most preferably at 300° C. Heat treatment may start directly at high temperature or via a ramp of temperature at a rate comprised between 1° C./min to 20° C./min. Heat treatment may finish with an air quenching or via natural cooling from the heating temperature or via a controlled ramp of temperature at a rate comprised between 1° C./min to 20° C./min.

Such as treatment may be made under an inert atmosphere comprising an inter gas such as dry N₂, or dry Argon (dry may refer to a gas with less than 800 ppm of liquid and airborne forms of water, including condensation). Preferably the inert atmosphere is a protective gas atmosphere used in order to minimize, preferably exclude access of oxygen and moisture.

The pressure at the time of heating may be at normal pressure or under reduced pressure. The atmosphere may be inert gas, such as nitrogen and argon. The dew point of the inert gas is preferably −20° C. or less, with −40° C. or less being particularly preferable. The pressure may be from 0.0001 Pa to 100 MPa, preferably from 0.001 Pa to 20 MPa, preferably from 0.01 Pa to 20 MPa. Notably the pressure may range from 0.0001 Pa to 0.001 Pa, notably by using ultravacuum techniques. Notably the pressure may range from 0.01 Pa to 0.1 MPa by using primary vacuum techniques.

Preferably the process for production of a solid material according to general formulas (I), (Ia), (II), (IIa), (III), (IIIa), (IV), (IVa), (V) and (Va) further comprises a step (c) of calcinating the solid material obtained in step (b).

Calcination is carried out at a temperature from about 100° C. to about 500° C., preferably from about 200° C. to about 400° C., more preferably from about 250° C. to about 350° C., most preferably at about 300° C., for about 30 minutes to about 4 hours, preferably from about 1 hour to about 3 hours, more preferably for about 2 hours, preferably with a heating ramp of 5° C./min. Preferably, calcination is carried out under vacuum.

It is also possible to treat the solid material to the desired particle size distribution, notably after step b), step c) or after the heat treatment. If necessary, the solid material obtained by the process according to the invention is ground (e.g. milled) into a powder.

Milling can be carried out by mechanical milling at about 100 rpm to 1000 rpm, notably for a duration from 10 minutes to 80 hours more preferably for about 4 hours to 40 hours. In the mechanical milling method, various methods such as a rotation ball mill, a tumbling ball mill, a vibration ball mill and a planetary ball mill or the like can be used. Mechanical milling may be made with or without balls such as ZrO₂.

Preferably, said powder has a D50 value of the particle size distribution of less than 100 μm, more preferably less than 10 μm, most preferably less than 5 μm, as determined by means of dynamic light scattering or image analysis.

Preferably, said powder has a D90 value of the particle size distribution of less than 100 μm, more preferably less than 10 μm, most preferably less than 5 μm, as determined by means of dynamic light scattering or image analysis. Notably, said powder has a D90 value of the particle size distribution comprised from 1 μm to 100.

Should the disclosure of any patents, patent applications, and publications which are incorporated herein by reference conflict with the description of the present application to the extent that it may render a term unclear, the present description shall take precedence.

### EXPERIMENTAL PART

The examples below serve to illustrate the invention, but have no limiting character.

### X-Ray Diffraction

The XRD diffractograms of the powders were acquired on a XRD goniometer in the Bragg Brentano geometry, with a Cu X Ray tube (Cu Kalpha wavelength of 1.5406 Å). The setup may be used in different optical configurations, i.e. with variable or fixed divergence slits, or Soller slits. A filtering device on the primary side may also be used, like a monochromator or a Bragg Brentano HD optics from Panalytical. If variable divergence slits are used; the typical illuminated area is 10 mm×10 mm. The sample holder is loaded on a spinner; rotation speed is typically 60 rpm during the acquisition. Tube settings were operating at 40 kV/30 mA for variable slits acquisition and at 45 kV/40 mA for fixed slits acquisition with incident Bragg Brentano HD optics. Acquisition step was 0.017° per step. Angular range is typically 5° to 90° in two theta or larger. Total acquisition time was typically 30 min or longer. The powders are covered by a Kapton film to prevent reactions with air moisture.

### Conductivity Measurements

The conductivity was acquired on pellets done using a uniaxial press operated at 500MPa. Pelletizing was done using a lab scale uniaxial press in glovebox filled with moisture free Argon atmosphere. Two carbon paper foils (Papyex soft graphite N998 Ref: 496300120050000, 0.2 mm thick from Mersen) are used as current collector. The measurement is done in a swagelock cell closed using a manual spring. The impedance spectra are acquired on a Biologic VMP3 device and the control of temperature is ensured by a Binder climatic chamber. Duration of two hours is set to allow the temperature to be equilibrated between two measurements. Impedance spectroscopy is acquired in PEIS mode with an amplitude of 10 mV and a range of frequencies from 1 MHz to 1 kHz (25 points per decade and a mean of 50 measurements per frequency point). Electronic conductivities are acquired by imposing a potential difference of 1 V during 2 minutes and measuring the resultant current to extract the electronic resistance of the pellet.

### Example 1: Comparative—Li₃YCl₆ by Dry Mechanochemistry—Using YCl₃·6H₂O

The weighing of precursors and preparation of the sample was carried out in an Ar-filled glovebox with oxygen and moisture levels both below 1 ppm. In a typical experiment, a 30 mL glass vial has been used to weight LiCl (≥99.9%, Sigma Aldrich, 0.74 g) and YCl₃·6H₂O (≥99%, Sigma Aldrich, 1.76 g) according to the target stoichiometry Li₃YCl₆. The sample was poured in a 45 mL ZrO₂ milling jar which contains 66 g of diameter 5 mm ZrO₂ balls. The jar was equipped with a Viton seal and hermetically closed (Ar atmosphere inside the jar). The jar was removed from the glovebox and set inside a planetary ball-milling (Pulverisette 7 premium line, Fritsch). The mechanosynthesis was carried out at 800 rpm during 10 min for 165 cycles with a 30 min rest period between each cycle. After the end of the mechanosynthesis the jar was entered in the glovebox. The grey powder obtained has been recovered and the XRD was in accordance with a mixture of LiCl and YCl₃·6H₂O, indicating that the reaction did not occur.

The transport properties of the grey powder are measured after pelletizing:
Ionic conductivity measured at 30° C.: below 10⁻⁸ S/cm

### Example 2: Comparative—Li₃YCl₆ by Wet Mechanochemistry Using Inert Solvent—Using YCl₃·6H₂O

The weighing of precursors and preparation of the sample was carried out in an Ar-filled glovebox with oxygen and moisture levels both below 1 ppm. In a typical experiment, a 30 mL glass vial has been used to weight LiCl (≥99.9%, Sigma Aldrich, 0.74 g) and YCl₃·6H₂O (≥99%, Sigma Aldrich, 1.76 g) according to the target stoichiometry Li₃ YCl₆. The sample was poured in a 45 mL ZrO₂ milling jar which contains 66 g of Ø 5 mm ZrO₂ balls. Then 2.5 g of anhydrous para-xylene was poured on top of the balls and powder. The jar was equipped with a Viton seal and hermetically closed (Ar atmosphere inside the jar). The jar was removed from the glovebox and set inside a planetary ball-milling (Pulverisette 7 premium line, Fritsch). The mechanosynthesis was carried out at 800 rpm during 10 min for 165 cycles with a 30 min rest period between each cycle. After the end of the mechanosynthesis the jar was entered in the glovebox. The product and the balls were set inside two 30 mL glass vials (without caps) placed themselves in a glass tube. The tube was closed, removed from the glovebox and set in a Glass Oven B-585 from Büchi. The sample was dried under vacuum at 110° C. for 5 h after a heating ramp of 5° C./min to evaporate the p-xylene. The grey powder obtained is recovered and the XRD is in accordance with a mixture of LiCl, YCl₃·6H₂O and traces of Li₃YCl₆ indicating that the reaction did not occur.

The transport properties of the grey powder are measured after pelletizing:
Ionic conductivity measured at 30° C.: below 10⁻⁸ S/cm

### Example 3: Comparative—Li₃YCl₆ by Solution Route-Using Anhydrous YCl₃, in Ethanol

The weighing of precursors and preparation of the sample was carried out in an Ar-filled glovebox with oxygen and moisture levels both below 1 ppm. In a typical experiment, a 30 mL glass vial has been used to weight LiCl (≥99.9%, Sigma Aldrich, 1.25 g), dry YCl₃ (≥99.9%, Sigma Aldrich, 1.72 g) and absolute ethanol (≥99%, Sigma Aldrich, 20 g) according to the target stoichiometry Li₃YCl₆. The mixture was shaken for several minutes in order to fully solvate the precursors. After that, 6 g of the solution was transferred into a separate 10 mL vial. This bottle was then set in a Glass Oven B-585 from Büchi, taken out and dried under vacuum at 70° C. for 2 hours. The resulting powder was calcined at 300° C. for 2 hours under vacuum, with a heating ramp of 5° C./min. Then the powder was analyzed by XRD and its conductivity was measured. The XRD pattern is in accordance with the formation of Li₃YCl₆ phase with presence of LiCl impurities.

The transport properties of the grey powder are measured after pelletizing:
Ionic conductivity measured at 30° C.: 2E⁻⁵ S/cm

### Example 4: Li₃YCl₆ by Solution Route-Using YCl₃·6H₂O in Ethanol

The weighing of precursors and preparation of the sample was carried out in an Ar-filled glovebox with oxygen and moisture levels both below 1 ppm. In a typical experiment, a 30 mL glass vial has been used to weight LiCl (≥99.9%, Sigma Aldrich, 0.59 g), YCl₃·6H₂O (≥99.9%, Sigma Aldrich, 1.41 g) and absolute ethanol (≥99%, Sigma Aldrich, 20 g) according to the target stoichiometry Li₃YCl₆. The mixture was shaken for several minutes in order to fully solvate the precursors. After that, 6 g of the solution was transferred into a separate 10 mL vial. This bottle was then set in a Glass Oven B-585 from Büchi, taken out and dried under vacuum at 70° C. for 2 hours. The resulting powder was calcined at 300° C. for 2 hours under vacuum, with a heating ramp of 5° C./min. Then, the powder was analyzed by XRD and its conductivity was measured. The XRD pattern is in accordance with the formation of Li₃YCl₆ phase with presence of important amount of LiCl impurities.

The transport properties of the grey powder are measured after pelletizing:
Ionic conductivity measured at 30° C.: 6E⁻⁶ S/cm

### Example 5: Li₃YCl₆ by Solution Route—Using YCl₃·6H₂O, in Dry Ethanol

The weighing of precursors and preparation of the sample was carried out in an Ar-filled glovebox with oxygen and moisture levels both below 1 ppm. In a typical experiment, a 30 mL glass vial has been used to weight LiCl (≥99.9%, Sigma Aldrich, 0.59 g), YCl₃·6H₂O (≥99.9%, Sigma Aldrich, 1.41 g) and absolute ethanol (≥99%, Sigma Aldrich, 20 g) according to the target stoichiometry Li₃ YCl₆. The mixture was shaken for several minutes in order to fully solvate the precursors. After that, 6 g of the solution was transferred into a separate 10 mL vial. 10 g of molecular beads were added to the solution and the bottle was left in an Argon filled glove box for 3 days. Molecular beads were removed and the bottle was then set in a Glass Oven B-585 from Büchi, taken out and dried under vacuum at 70° C. for 2 hours. The resulting powder was calcined at 300° C. for 2 hours under vacuum, with a heating ramp of 5° C./min. Then, the powder was analyzed by XRD and its conductivity was measured. The XRD pattern is in accordance with the formation of Li₃ YCl₆ phase with presence of traces of LiCl impurities.

The transport properties of the grey powder are measured after pelletizing:
Ionic conductivity measured at 30° C.: 2E⁻⁵ S/cm

1. A process for the preparation of a solid material according to general formula (I) as follows:
Li_{6-3x-my}REₓT_{y}X₆ (I)
wherein:
X is a halogen;
m is the valence of the element T
0<x+(m/3)y<2;
0≤y≤0.8;
RE denotes one or more rare earth metals; the rare earth metals are different from each other; and
T is selected from the group consisting of Zr, Hf, Al, Zn, Mg, Ca, Sr, Bi, Nb, Fe and Ta;
said process comprising the step of:
a) dissolving lithium halide, at least one hydrated rare-earth metal halide and optionally T halide in a solvent to obtain a solution

2. The process according to claim 1 wherein the solid material is any one of the compounds of formulas (II) to (V) as follows:
Li_{6-3x-my}RE1ₐRE2_{b}T_{y}X₆ (II)
wherein a+b=x, with 0.05≤a≤0.95 and 0.0<b≤0.95;
Li_{6-3x-my}RE1ₐRE2_{b}RE3_{c}T_{y}X₆ (III)
wherein a+b+c=x, with 0.05≤a≤0.95, 0.0<b≤0.95 and 0.0<c≤0.95 with 0.05≤b+c;
Li_{6-3x-my}RE1ₐRE2_{b}RE3_{c}RE4_{d}T_{y}X₆ (IV)
wherein a+b+c+d=x, with 0.05≤a≤0.95, 0.0<b≤0.95, 0.0<c≤0.95 and 0.0<d≤0.95 with 0.05≤b+c+d;
Li_{6-3x-my}RE1ₐRE2_{b}RE3_{c}RE4_{c}RE5_{d}T_{y}X₆ (V)
wherein a+b+c+d+e=x, with 0.05<a≤0.95, 0.0<b≤0.95, 0.0<c≤0.95, 0.0<d≤0.95 and 0.0<e≤0.95, with 0.05≤b+c+d+e; and
wherein
X is a halogen,
m is the valence of the element T;
0<x+(m/3)y<2; preferably 0.8<x+(m/3)y<1.5; more preferably 0.95≤x+(m/3)y≤1.25;
0≤y≤0.8; preferably 0.1<y<0.7; more preferably 0.2≤y≤0.6;
RE1 is selected from the group consisting of Y, Yb, Ho and Er;
RE2 is selected from the group consisting of Yb, Ho, Gd, Er, Sm, Dy, La, Nd, Ce and Tb;
RE3 is selected from the group consisting of Ho, Gd, Er, Sm, Dy La, Nd, Ce and Tb;
RE4 is selected from the group consisting of Er, Gd Sm, Dy La, Nd, Ce and Tb; and
RE5 is selected from the group consisting of Gd Sm, Dy La, Nd, Ce and Tb; where RE1, RE2, RE3, RE4 and RE5 are different; and
T is selected from the group consisting of Zr, Hf, Al, Zn, Mg, Ca, Sr, Bi, Nb, Fe and Ta.

3. The process according to claim 1, wherein the lithium halides are selected from the group consisting of LiCl, LiBr, LiF, and LiI.

4. The process according to claim 1, wherein the hydrated rare-earth metal halides are selected from the group consisting of YCl₃·6H2O, ErCl₃·6H2O, YbCl₃·6H2O, GdCl₃·6H2O, LaCl₃·6H2O, YBr₃·6H2O, ErBr₃·6H2O, YbBr₃·6H2O, GdBr₃·6H2O, LaBr₃·6H2O, (Y, Yb, Er)Cl₃·6H2O and (La, Y)Cl₃·6H2O.

5. The process according to claim 1, wherein the T halide is ZrCl₄.

6. The process according to claim 1, wherein the solvent is selected from the group consisting of alcohols, nitriles and ethers.

7. The process according to claim 6 wherein the alcohol is selected from the group consisting of methanol, ethanol, n-propanol, iso-propanol and butanol.

8. The process according to claim 6 wherein the ether is tetrahydrofuran.

9. The process according to claim 6 wherein the nitrile is acetonitrile.

10. The process according to claim 1, wherein the solvent is a dry solvent.

11. The process according to claim 1, wherein step a) is carried out with stoichiometric amounts of a lithium halide and at least one hydrated rare-earth metal halide.

12. The process according to claim 1, wherein the process further comprises the step of:
b) removing at least a part of the solvent from the solution obtained in step (a) in order to obtain the solid material.

13. The process according to claim 12 wherein the process further comprises the step of:
c) calcinating the solid material obtained in step (b).

14. The process according to claim 13 wherein the calcinating is carried out from about 100° C. to about 500° C. for at least 1 hour.

15. The process according to claim 1, wherein at least one of steps a) to c) is carried out under inert atmosphere.
